(19) United States
(12) Patent Application Publication
(10) Pub. No.: US 2026/0310346 A1
(43) Pub. Date: Oct. 8, 2026

(54) DISPLAY METHOD AND APPARATUS, DEVICE, MEDIUM AND PRODUCT

(71) Applicant: Bytedance Technology Ltd., Grand Cayman (KY)

(72) Inventor: Ziyan LI, Beijing (CN)

(21) Appl. No.: 19/637,653

(22) Filed: Apr. 2, 2026

(30) Foreign Application Priority Data
Apr. 2, 2025 (CN) 202510412385.0

(51) Int. Cl. G06F 3/0488; G06F 3/0484

(52) U.S. Cl. CPC G06F 3/0488; G06F 3/0484

(57) ABSTRACT

The present disclosure provides a display method and apparatus, a computing device, a computer storage medium and a computer program product. The method includes: receiving a gesture input in a first display state of an interface; selecting a display state switching scheme from multiple display state switching schemes; and switching the interface from the first display state to a second display state, based on a displacement and a speed of the gesture input and the selected display state switching scheme.

### CROSS-REFERENCE TO RELATED APPLICATION(S)

This application claims priority to Chinese Patent Application No. 202510412385.0 filed on Apr. 2, 2025, the disclosure of which is incorporated herein by reference in its entirety.

### FIELD

The present disclosure relates to the technical field of computers, and more specifically, to a display method and apparatus, a computing device, a computer storage medium and a computer program product.

### BACKGROUND

In the current interaction interface design, the drag gesture, as a core operation for state switching (e.g., page flipping, menu expansion/collapse, mode switching, or the like), relies on t a static displacement threshold determination logic. However, relying solely on the displacement threshold cannot accommodate users'diverse operation patterns. For example, a user's intention in a quick swipe (high speed, small displacement) may be ignored by the system.

### SUMMARY

In a first aspect of embodiments of the present disclosure, there is provided a display method, comprising: receiving a gesture input in a first display state of an interface; selecting a display state switching scheme from multiple display state switching schemes; and switching the interface from the first display state to a second display state, based on a displacement and a speed of the gesture input and the selected display state switching scheme.

In a second aspect of embodiments of the present disclosure, there is provided a display apparatus, comprising: an input unit configured to receive a gesture input in a first display state of an interface; a scheme selection unit configured to select a display state switching scheme from multiple display state switching schemes; and a display state switching unit configured to switch the interface from the first display state to a second display state, based on a displacement and a speed of the gesture input and the selected display state switching scheme.

In a third aspect of embodiments of the present disclosure, there is provided an electronic device, comprising: at least one processing unit; and at least one memory coupled to the at least one processing unit and storing instructions executable by the at least one processing unit, wherein the instructions, when executed by the at least one processing unit, cause the electronic device to perform the method in the first aspect of the present disclosure.

In a fourth aspect of the present disclosure, there is provided a non-transitory computer storage medium, comprising machine-executable instructions that, when executed by a device, cause the device to perform the method in the first aspect of the present disclosure.

In a fifth aspect of the present disclosure, there is provided a computer program product comprising machine-executable instructions that, when executed by a device, cause the device to perform the method in the first aspect of the present disclosure.

The Summary is to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

With reference to the following detailed description of the accompanying drawings, the above and other objectives, features, and advantages of the embodiments of the present disclosure will be made clearer. Wherein:

FIG. 1 illustrates a schematic diagram of an example environment where multiple embodiments of the present disclosure can be implemented;

FIG. 2 illustrates a flowchart of a method for displaying an interface according to some embodiments of the present disclosure;

FIG. 3 illustrates a flowchart of a method for determining a display state according to some embodiments of the present disclosure;

FIG. 4 illustrates a block diagram of an apparatus for displaying an interface according to some embodiments of the present disclosure; and

FIG. 5 illustrates a block diagram of a device that can implement multiple embodiments of the present disclosure.

Throughout the drawings, the same or similar reference numerals represent the same or similar elements.

### DETAILED DESCRIPTION OF EMBODIMENTS

It would be appreciated that all user-related data involved in the present technical solution should be obtained and used after user authorization has been gained. In other words, according to the present technical solution, if user's personal information is to be used, express consent and authorization from the user are required before obtaining the data; otherwise, the related data should not be collected or used. Further, when the technical solution is being carried out, the behavior of collecting, using and storing the data should strictly comply with the relevant laws and regulations, and necessary technologies and measures should be adopted to protect the user data security and ensure safe use of the data.

Prior to applying the technical solution, in accordance with the relevant laws and regulations, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

Reference below will be made to describe the embodiments of the present disclosure in detail. Although some embodiments of the present disclosure are depicted in the drawings, it would be appreciated that the present disclosure could be implemented in various forms and should not be construed as being restricted to the embodiments described herein. Rather, those embodiments are provided to enable a more thorough and complete understanding of the present disclosure. It is to be understood that the drawings and embodiments of the present disclosure are provided only exemplarily, but not used to limit the protection scope of the present disclosure.

As described herein, the term “includes” or similar expressions are to be read as open-ended terms that mean “includes, but is not limited to.” The term “based on” is to be read as “based at least in part on.” The term “an embodiment” or “the embodiment” is to be read as “at least one embodiment.” The terms “first,” “second,” and the like may refer to different objects or the same object unless explicitly indicated otherwise. Other definitions, explicit and implicit, may be included below.

As mentioned above, current interaction designs that rely solely on displacement thresholds cannot accommodate users'diverse operation patterns. For example, in the current interactive interfaces, drag operations for switching the display state of an interface typically adopt a single-dimensional displacement threshold determination method. However, such method cannot adapt to different user operation habits. Some users may perform gesture swipes on the interface with a small displacement, which fails to enable the interface to switch to the next display state quickly and smoothly, thereby affecting the user interaction experience. Therefore, it is urgently necessary to design a display state switching method that is faster and more accurate.

To this end, the present disclosure provides a method for displaying an interface. The method includes: receiving a gesture input in a first display state of an interface; selecting a display state switching scheme from multiple display state switching schemes; and switching the interface from the first display state to a second display state, based on a displacement and a speed of the gesture input and the selected display state switching scheme. With the method, a display state switching scheme more in line with the user's needs can be selected from the multiple display state switching schemes, and it can be determined to switch the interface from the first display state to the second display state based on the selected display state switching scheme and in conjunction with a combination of the displacement and the speed of the gesture input and a comparison with the selected display state switching scheme. The method enables the interface display state switching to be determined based on a combination of the speed and the displacement, rather than based on the displacement only. Moreover, multiple display state switching schemes are introduced into the method, thus optimizing the experience for different application scenarios and improving the user experience in interacting with a device.

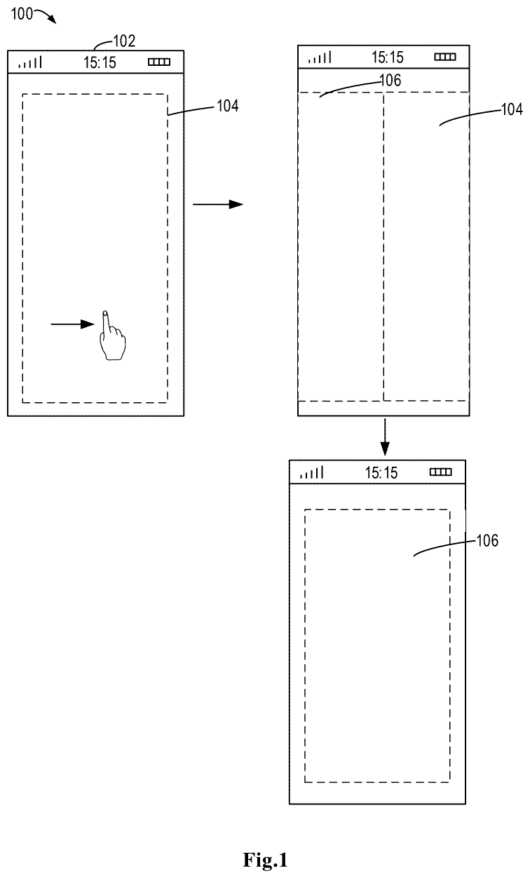

FIG. 1 illustrates a schematic diagram of an example environment 100 where multiple embodiments of the present disclosure can be implemented. As shown therein, the example environment 100 may include a terminal device 102 that may be an electronic device having data processing and display functionalities and equipped with a user interface for users to interact therewith, for example, a smartphone, a tablet, a laptop, a smart wearable device, and the like. The interface of the terminal device 102 can obtain a gesture input from a user, and operate a display state of the interface based on the obtained gesture input. Wherein, the display state refers to a presentation form or a functional mode of a user interface in a different interaction scenario. For example, the display state may be a page/view (e.g., an information page, an album page, a video page, or the like) of an application displayed by the terminal device 102, or may be a display of an element (e.g., expanding/collapsing a menu bar or hiding a sidebar, or the like), or may be a dynamic special-effect display (e.g., an animation effect of an element), which is not limited herein.

In some embodiments, the terminal device 102 may have a first display state 104 and a second display state 106 that can be switched to each other. It would be appreciated that the terminal device 102 may have more display states. The terminal device 102 can display a first element in the first display state 104. In response to determining to switch the interface from the first display state 104 to the second display state 106, the terminal device 102 can display a second element in the second display state 106. By way of example, the first display state 104 may be a current information page, and the second display state 106 may be a next information page; the first display state 104 may also be a display of a current element (e.g., an animation effect), and the second display state 106 may be a display of a next element (e.g., a next animation effect), which is not limited herein. The terminal device 102 can receive a gesture input in the first display state 104 from the user, and determine, based on the gesture input, to switch the interface from the first display state 104 to the second display state 106.

In some embodiments, the terminal device 102 can determine a direction of the gesture input, and determine a display state switching direction based on the direction of the gesture input. By way of example, the terminal device 102 can determine that the user has applied to the first display state 104 a gesture input of moving to the right, and can determine, based on the gesture input, that the second display state 106 is gradually displayed from the left side, and the interface is switched from the first display state 104 to the second display state 106. Likewise, if the gesture input is in the opposite direction, the interface can be switched from the second display state 106 to the first display state 104.

In some embodiments, the terminal device 102 can determine a displacement of the gesture input, and can determine, based on the displacement of the gesture input, whether the display state of the interface is the first display state 104 or the second display state 106. By way of example, when determining that the displacement of the gesture input is less than a predefined displacement threshold, the terminal device 102 can determine that the first display state 104 is displayed; when determining that the displacement of the gesture input is greater than or equal to the predefined displacement threshold, the terminal device 102 can determine that the second display state 106 is displayed.

In some embodiments, the terminal device 102 can determine, based on a combination of the displacement and the speed of the gesture input, whether the display state of the interface is the first display state 104 or the second display state 106. By way of example, when determining that the displacement of the gesture input is greater than or equal to a predefined displacement threshold, the terminal device 102 can determine that the second displace state 106 is displayed; when determining that the speed of the gesture input is greater than or equal to a predefined speed threshold, the terminal device 102 can determine that the second display state 106 is displayed. In some embodiments, when determining that the displacement of the gesture input is less than the predefined displacement threshold and the speed of the gesture input is less than the predefined speed threshold, the terminal device 102 can determine that the first display state 104 is displayed. In some embodiments, the speed threshold and the displacement threshold can be combined as a display state switching scheme, and different speed thresholds and different displacement thresholds are combined into different display state switching schemes, which reflect the switching sensitivity, that is, whether the switching of the display state is triggered more easily or with more difficulty.

With the method, the terminal device can determine whether to switch the display state based on a combination of the displacement and speed of the user's gesture input, which is more accurate than determining whether to switch the display state based solely on displacement, thereby improving the interaction experience.

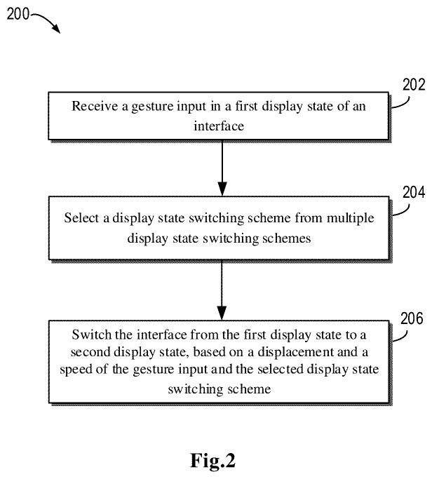

FIG. 2 illustrates a flowchart of an interface display method 200 according to some embodiments of the present disclosure. The method 200 can be performed by a terminal device which may be the terminal device 102 in the example environment 100. The method 200 includes a block 202, a block 204 and a block 206.

As shown therein, in block 202, a gesture input is received in a first display state of an interface. Referring to FIG. 1, the terminal device 102 can receive a gesture input in the first display state 104. Based on the gesture input, the terminal device 102 can determine a movement direction of the first display state 104, and can determine, based on the gesture input, whether the interface is switched to the first display state.

In block 204, a display state switching scheme is selected from multiple display state switching schemes. Referring to FIG. 1, the terminal device 102 can determine a display state switching scheme from multiple predefined display state switching schemes. In some embodiments, the terminal device 102 can select a display state switching scheme according to a different application scenario. For example, for an information application, users generally avoid false triggering which may cause an easy switch of the display state. In the scenario, the terminal device 102 can select a scheme with a greater switching threshold from the multiple display state switching schemes.

In block 206, the interface is switched from the first display state to the second display state, based on the displacement and the speed of the gesture input, and the selected display state switching scheme. Referring to FIG. 1, the terminal device 102 can determine that the interface is switched from the first display state 104 to the second display state 106, based on the combination of the displacement and the speed of the gesture input, and the displacement threshold and the speed threshold included in the selected display state switching scheme.

In this way, display state switching schemes can be determined according to different application scenarios, and it can be determined, based on a combination of a displacement and a speed of a gesture input from a user, whether the interface is switched from the current display state to a next display state, which can improve the switching accuracy; and a display state switching scheme can be selected according to a specific application scenario, enabling the display state switching to be more in line with the user's personalized needs.

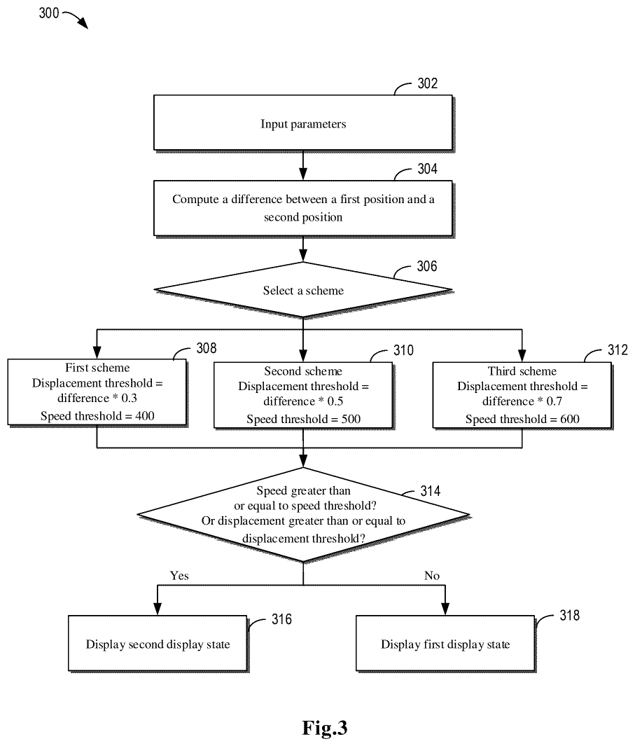

FIG. 3 illustrates a flowchart of a method 300 for determining a display state according to some embodiments of the present disclosure. The method 300 can be performed by a terminal device, for example, the terminal device 102 in the example environment 100. The method 300 includes a block 302 through a block 318.

In block 302, the terminal device 102 obtains input parameters. By way of example, the input parameters may be a displacement and a speed of a gesture input in a first display state from a user. In block 304, a difference between a first position and a second position is computed. The first position and the second position may be position information indicating spatial information of the first display state 104 and the second display state 106. For example, the first position may indicate a position of the first display state 104 on the interface, and the second position may indicate a position of the second display state 106 on the interface, which may be coordinate information of the interface, for example. The first position and the second position may be virtual position information which may be outside the interface, for example. In some embodiments, the terminal device 102 can determine a first position corresponding to the first display state 104 and a second position corresponding to the second display state 106.

In block 306, the terminal device 102 can select a scheme. In some embodiments, the terminal device 102 can select a display state switching scheme from multiple display state switching schemes. Wherein, the multiple display state switching schemes include a first scheme 308, a second scheme 310 and a third scheme 312, and have respective displacement thresholds and respective speed thresholds. In some embodiments, the first displacement threshold of the first scheme 308 is less than the second displacement threshold of the second scheme 310, the second displacement threshold is less than the third displacement threshold of the third scheme 312; and the first speed threshold of the first scheme 308 is less than the second speed threshold of the second scheme 310, and the second speed threshold is less than the third speed threshold of the third strategy 312. In some embodiments, the terminal device 102 can select a display state switching scheme from the multiple display state switching schemes according to an application scenario, where the application scenario includes one of a text application, a picture application or a video application.

In some embodiments, the terminal device 102 can determine displacement thresholds of the multiple displacement switching schemes based on the first position, the second position and coefficients. By way of example, the terminal device 102 can determine respective displacement thresholds of different schemes based on the first position, the second position and multiple coefficients. For example, for the first scheme 308, the terminal device 102 can determine that the scheme is an easy-switching scheme, set the coefficient to 0.3, and therefore determine the displacement threshold of the first scheme 308 based on a product of the coefficient 0.3 and the difference between the first position and the second position; for the second scheme 310, the terminal device 102 can determine that the scheme is an intermediate scheme, set the coefficient to 0.5, and therefore determine the displacement threshold of the second scheme 310 based on a product of the coefficient 0.5 and the difference between the first position and the second position; for a third scheme 312, the terminal device 102 can determine that the scheme is a hard-switching scheme, set the coefficient to 0.7, and therefore determine the displacement threshold of the third scheme 312 based on a product of the coefficient 0.7 and the difference between the first position and the second position.

In some embodiments, the terminal device 102 can determine speed thresholds of the multiple different schemes. By way of example, for the first scheme 308, the terminal device 102 can set the speed threshold to 400 units/second; for the second scheme 310, the terminal device 102 can set the speed threshold to 500 units/second; for the third scheme 312, the terminal device 102 can set the speed threshold to 600 units/second. It would be appreciated that setting displacement thresholds and speed thresholds, as described above, is provided only for illustration and could be adjusted in practice as actually required, which is not limited herein.

In block 314, it is determined whether the speed is greater than or equal to the speed threshold, or whether the displacement is greater than or equal to the displacement threshold; if yes, the method proceeds to the block 316 to display the second display state; if no, the method proceeds to the block 318 to display the first display state. In some embodiments, the terminal device 102 can obtain a combination of the speed and the displacement of the gesture input, and determine whether the speed of the gesture input is greater than or equal to the speed threshold, and whether the displacement of the gesture input is greater than or equal to the displacement threshold. By way of example, in response to selecting the first scheme 308, the terminal device 102 determines whether the speed of the gesture input is greater than or equal to the speed threshold 400 units/second, and determines to switch the interface from the first display state 104 to the second display state 106 and displays the second display state 106 if the speed of the gesture input is greater than or equal to the speed threshold of the first scheme 308; or the terminal device 102 determines whether the displacement of the gesture input is greater than or equal to the displacement threshold of the first scheme 308, and determines to switch the interface from the first display state 104 to the second display state 106 if the displacement of the gesture input is greater than or equal to the displacement threshold of the first scheme 308. In response to determining that the speed of the gesture input is less than the speed threshold 400 units/second of the first scheme 308 and the displacement of the gesture input is less than the displacement threshold of the first scheme 308, the terminal device 102 maintains the interface in the first display state 104.

In some embodiments, in response to selecting the second scheme 310, the terminal device 102 determines whether the speed of the gesture input is greater than or equal to the speed threshold 500 units/second, and determines to switch the interface from the first display state 104 to the second display state 106 and displays the second display state 106 if the speed of the gesture input is greater than or equal to the speed threshold of the second scheme 310; or the terminal device 102 determines whether the displacement of the gesture input is greater than or equal to the displacement threshold of the second scheme 310, and determines to switch the interface from the first display state 104 to the second display state 106 if the displacement of the gesture input is greater than or equal to the displacement threshold of the second scheme 310. In response to determining that the speed of the gesture input is less than 500 units/second of the second scheme 310 and the displacement of the gesture input is less than the displacement threshold of the second scheme 310, the terminal device 102 maintains the interface in the first display state 104.

In some embodiments, in response to selecting the third scheme 312, the terminal device 102 determines whether the speed of the gesture input is greater than or equal to the speed threshold 600 units/second, and determines to switch the interface from the first display state 104 to the second display state 106 and displays the second display state 106 if the speed of the gesture input is greater than or equal to the speed threshold of the third scheme 312; or the terminal device 102 determines whether the displacement of the gesture input is greater than or equal to the displacement threshold of the third scheme 312, and determines to switch the interface from the first display state 104 to the second display state 106 if the displacement of the gesture input is greater than or equal to the displacement threshold of the third scheme 312. In response to determining that the speed of the gesture input is less than 600 units/second of the third scheme 312 and the displacement of the gesture input is less than the displacement threshold of the third scheme 312, the terminal device 102 maintains the interface in the first display state 104.

The example embodiments described above with reference to FIGS. 1-3 provide a method for determining interface state switching based on a display state switch scheme selected from multiple display state switching schemes, and a combination of a speed and a displacement of a gesture input. As compared with the prior art, such method has the advantage of determining different display state switching schemes according to different application scenarios, thus being more in line with the user's interaction needs. In addition, by determining whether the display state switching is performed, based on the combination of the speed and the displacement of the gesture input from the user and the comparisons with the displacement threshold and the speed threshold, the method is more accurate, thus improving the user experience.

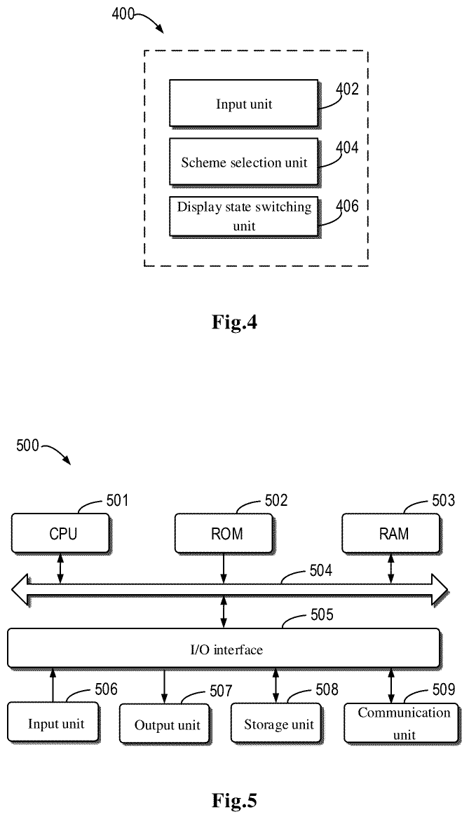

FIG. 4 illustrates a block diagram of an interface display apparatus 400 according to some embodiments of the present disclosure. As shown therein, the apparatus 400 includes an input unit 402 configured to receive a gesture input in a first display state of an interface. The apparatus 400 further includes a scheme selection unit 404 configured to select a display state switching scheme from multiple display state switching schemes. The apparatus 400 also includes a display state switching unit 406 configured to switch the interface from the first display state to a second display state, based on a displacement and a speed of the gesture input and the selected display state switching scheme.

In some embodiments, the multiple display state switching schemes have respective displacement thresholds and speed thresholds.

In some embodiments, the display state switching unit 406 can also be configured to: in response to the displacement of the gesture input being greater than or equal to the displacement threshold, or in response to the speed of the gesture input being greater than or equal to the speed threshold, switch the interface from the first display state to the second display state.

In some embodiments, the display state switching unit 406 can be further configured to: determine, for a display state switching scheme among the multiple display state switching schemes, a first position corresponding to the first display state; determine a second position corresponding to the second display state; and determine the displacement threshold of the display state switching scheme, based on the first position, the second position and a coefficient.

In some embodiments, the multiple display state switching schemes comprise a first scheme, a second scheme and a third scheme, a first displacement threshold of the first scheme is less than a second displacement threshold of the second scheme, and the second displacement threshold is less than a third displacement threshold of the third scheme, and wherein a first speed threshold of the first scheme is less than a second speed threshold of the second scheme, and the second speed threshold is less than a third speed threshold of the third scheme.

In some embodiments, the display state switching unit 406 can be further configured to: in response to the displacement being less than the displacement threshold in the display state switching scheme and the speed being less than the speed threshold in the display state switching scheme, maintain the interface in the first display state.

In some embodiments, the display state switching unit 406 can be further configured to: select a display state switching scheme from the multiple display state switching schemes, according to an application scenario that comprises one of a text application, a picture application and a video application.

In some embodiments, the apparatus 400 can be further configured to: display a first element in the first display state; and in response to the interface being switched from the first display state to the second display state, display a second element in the second display state.

FIG. 5 illustrates an example block diagram of an example device 500 that can implement embodiments of the present disclosure. As shown therein, the device 500 may include a central processing unit (CPU) and/or graphics processing unit (GPU) 501 which can execute various actions and processing based on programs stored in a Read Only Memory (ROM) 502 or a program loaded from a storage unit 508 to a Random Access Memory (RAM) 503. RAM 503 stores therein various programs and data required for operations of the device 500. The CPU/GPU 501, the ROM 502, and the RAM 503 are connected to one another via a bus 504. An input/output (I/O) interface 505 is also connected to the bus 504. Although not shown in FIG. 5, the device 500 may further include a coprocessor.

A plurality of components in the device 500 may be connected to the I/O interface 505, including: an input unit 506 including, for example, a keyboard, a mouse, and the like; an output unit 507 including various types of displays, loudspeakers, and the like; a storage unit 508 including, for example, a magnetic disk, a compact disc, or the like; and a communication unit 509, for example, a network card, a modem, a wireless communication transceiver, or the like. The communication unit 509 can allow the device 500 to exchange information/data with other devices through a computer network such as Internet, and/or various kinds of telecommunication networks.

The various methods or processes described above can be performed by the CPU/GPU 501. For example, the method may be implemented as computer software programs that are tangibly included in a machine readable medium, e.g., the storage unit 508. In some embodiments, part or all of the computer programs may be loaded and/or mounted onto the device 500 via ROM 502 and/or communication unit 509. When the computer program is loaded to the RAM 503 and executed by the CPU/GPU 501, one or more steps or postures of the method or process as described above can be executed.

In some embodiments, the method and process described above may be implemented as a computer program product. The computer program product may include a computer readable storage medium having stored thereon computer readable program instructions for performing various aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire.

Computer readable program instructions described herein can be downloaded to corresponding computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the corresponding computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGAs), or Programmable Logic Arrays (PLAs) may execute the computer readable program instructions by utilizing state information of the computer readable program instructions to personalize the electronic circuitry, in order to perform aspects of the present disclosure.

These computer readable program instructions may be provided to a processing unit of a general purpose computer, special purpose computer, or other programmable data processing device to produce a machine, such that the instructions, when executed via the processing unit of the computer or other programmable data processing device, create apparatuses for implementing the functions/actions specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored thereon includes an article of manufacture including instructions which implement aspects of the functions/actions specified in the flowchart and/or block diagram block or blocks.

The computer readable program instructions may also be loaded onto a computer, other programmable data processing devices, or other devices to cause a series of operational steps to be performed on the computer, other programmable devices or other devices to produce a computer implemented process, such that the instructions which are executed on the computer, other programmable devices, or other devices implement the functions/actions specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which includes one or more executable instructions for implementing the specified logical function(s). In some alternative implementations, the functions noted in the block may occur out of the order noted in the images. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

I/We claim:

1. A display method, comprising:
receiving a gesture input in a first display state of an interface;
selecting a display state switching scheme from multiple display state switching schemes; and
switching the interface from the first display state to a second display state, based on a displacement and a speed of the gesture input and the selected display state switching scheme.

2. The method of claim 1, wherein the multiple display state switching schemes have respective displacement thresholds and speed thresholds.

3. The method of claim 2, wherein switching the interface from the first display state to the second display state, based on the displacement and the speed of the gesture input and the selected display state switching scheme, comprises:
in response to the displacement of the gesture input being greater than or equal to the displacement threshold, or in response to the speed of the gesture input being greater than or equal to the speed threshold, switching the interface from the first display state to the second display state.

4. The method of claim 2, further comprising:
determining, for a display state switching scheme among the multiple display state switching schemes, a first position corresponding to the first display state;
determining a second position corresponding to the second display state; and
determining the displacement threshold of the display state switching scheme, based on the first position, the second position and a coefficient.

5. The method of claim 2, wherein the multiple display state switching schemes comprise a first scheme, a second scheme and a third scheme, a first displacement threshold of the first scheme is less than a second displacement threshold of the second scheme, and the second displacement threshold is less than a third displacement threshold of the third scheme, and wherein a first speed threshold of the first scheme is less than a second speed threshold of the second scheme, and the second speed threshold is less than a third speed threshold of the third scheme.

6. The method of claim 3, further comprising:
in response to the displacement being less than the displacement threshold in the display state switching scheme and the speed being less than the speed threshold in the display state switching scheme, maintaining the interface in the first display state.

7. The method of claim 1, wherein selecting a display state switching scheme from the multiple display state switching schemes comprises:
selecting a display state switching scheme from the multiple display state switching schemes, according to an application scenario that comprises one of a text application, a picture application and a video application.

8. The method of claim 1, further comprising:
displaying a first element in the first display state; and
in response to the interface being switched from the first display state to the second display state, displaying a second element in the second display state.

9. An electronic device, comprising:
a processor; and
a memory coupled to the processor and having instructions stored therein, wherein the instructions, when executed by the processor, cause the electronic device to perform a method comprising:
receiving a gesture input in a first display state of an interface;
selecting a display state switching scheme from multiple display state switching schemes; and
switching the interface from the first display state to a second display state, based on a displacement and a speed of the gesture input and the selected display state switching scheme.

10. The electronic device of claim 8, wherein the multiple display state switching schemes have respective displacement thresholds and speed thresholds.

11. The electronic device of claim 10, wherein switching the interface from the first display state to the second display state, based on the displacement and the speed of the gesture input and the selected display state switching scheme, comprises:
in response to the displacement of the gesture input being greater than or equal to the displacement threshold, or in response to the speed of the gesture input being greater than or equal to the speed threshold, switching the interface from the first display state to the second display state.

12. The electronic device of claim 10, the method further comprising:
determining, for a display state switching scheme among the multiple display state switching schemes, a first position corresponding to the first display state;
determining a second position corresponding to the second display state; and
determining the displacement threshold of the display state switching scheme, based on the first position, the second position and a coefficient.

13. The electronic device of claim 10, wherein the multiple display state switching schemes comprise a first scheme, a second scheme and a third scheme, a first displacement threshold of the first scheme is less than a second displacement threshold of the second scheme, and the second displacement threshold is less than a third displacement threshold of the third scheme, and wherein a first speed threshold of the first scheme is less than a second speed threshold of the second scheme, and the second speed threshold is less than a third speed threshold of the third scheme.

14. The electronic device of claim 11, the method further comprising:
in response to the displacement being less than the displacement threshold in the display state switching scheme and the speed being less than the speed threshold in the display state switching scheme, maintaining the interface in the first display state.

15. The electronic device of claim 9, wherein selecting a display state switching scheme from the multiple display state switching schemes comprises:
selecting a display state switching scheme from the multiple display state switching schemes, according to an application scenario that comprises one of a text application, a picture application and a video application.

16. The electronic device of claim 9, the method further comprising:
displaying a first element in the first display state; and
in response to the interface being switched from the first display state to the second display state, displaying a second element in the second display state.

17. A non-transitory computer-readable storage medium having computer-executable instructions stored thereon, wherein the computer-executable instructions are executed by a processor to perform a method comprising:
receiving a gesture input in a first display state of an interface;
selecting a display state switching scheme from multiple display state switching schemes; and
switching the interface from the first display state to a second display state, based on a displacement and a speed of the gesture input and the selected display state switching scheme.

18. The medium of claim 17, wherein the multiple display state switching schemes have respective displacement thresholds and speed thresholds.

19. The medium of claim 18, wherein switching the interface from the first display state to the second display state, based on the displacement and the speed of the gesture input and the selected display state switching scheme, comprises:
in response to the displacement of the gesture input being greater than or equal to the displacement threshold, or in response to the speed of the gesture input being greater than or equal to the speed threshold, switching the interface from the first display state to the second display state.

20. The electronic device of claim 18, the method further comprising:
determining, for a display state switching scheme among the multiple display state switching schemes, a firs position corresponding to the first display state;
determining a second position corresponding to the second display state; and
determining the displacement threshold of the display state switching scheme, based on the first position, the second position and a coefficient.
